(19) United States
(12) Patent Application Publication
(10) Pub. No.: US 2015/0286325 A1
(43) Pub. Date: Oct. 8, 2015

(54) FLAT PANEL DISPLAY

(71) Applicant: Samsung Display Co., Ltd., Yongin-city (KR)

(72) Inventor: Ki Hoon Kim, Yongin-city (KR)

(21) Appl. No.: 14/483,419

(22) Filed: Sep. 11, 2014

(30) Foreign Application Priority Data
Apr. 8, 2014 (KR) 10-2014-0041986

(51) Int. Cl. G06F 3/041; G06F 3/044

(52) U.S. Cl. CPC G06F 3/0412; G06F 3/044; G06F 2203/04103; G06F 2203/04107

(57) ABSTRACT

A flat panel display includes: upper and lower substrates, each partitioned into first and second non-display areas at an edge of a display area; sensing patterns in the display area of the upper substrate; sense lines in the first non-display area of the upper substrate and connected with the sensing patterns; a sense pad in the second non-display area of the upper substrate and connected with the sense lines; resistance reducing lines in the first non-display area of the upper substrate and connected with at least some sensing patterns; a sealing member between the upper substrate and the non-display area of the lower substrate; metal patterns in the second non-display area of the lower substrate, overlapping with the sense pad and the sense resistance pads; and a conductive ball area between the sense pad, the resistance reducing pads, and the metal patterns, and including conductive balls.

### CROSS-REFERENCE TO RELATED APPLICATION

This application claims priority to and the benefit of Korean Patent Application No. 10-2014-0041986 filed in the Korean Intellectual Property Office on Apr. 8, 2014, the entire contents of which are incorporated herein by reference.

### BACKGROUND

1. Field

The present disclosure relates to a flat panel display, and more particularly, it relates to a flat panel display provided with an integrally formed touch screen panel.

2. Description of the Related Technology

A touchscreen panel is an input device that receives a user's command by allowing the user to select an instruction displayed on a screen of an image display device with his or her hand, or with an object. To achieve this, the touchscreen panel is disposed on a front face of the image display device to convert a contact position, where the user's hand or the object touches, into an electrical signal. Accordingly, the instruction selected in the contact position is input as an input signal.

Since the touchscreen panel can be replaced with a separate input device that is connected to the image display device such as a keyboard or a mouse to be operated, there is a trend that a using range thereof is gradually expanded.

The touch panel includes a resistive touch screen panel, an optical type touch screen panel, a capacitive touch screen panel, and the like, and the touch screen panel is independently manufactured and then attached to an external surface of a display panel of a flat panel display.

However, when the independently manufactured touch screen panel is attached to the external surface of the display panel of the flat panel display, the entire thickness of the flat panel display is increased and manufacturing cost is also increased, and visibility of an image may be deteriorated due to a gap existing between the touch screen panel and the display panel.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present disclosure has been made in an effort to provide a flat panel display that can reduce the entire thickness thereof by utilizing an upper substrate of a display panel as a substrate of a touch screen panel, improve visibility of an image, and reduce resistance in wiring by additionally forming a resistance reducing pad in a touch sense pad.

According to one embodiment, a flat panel display includes: an upper substrate and a lower substrate, each partitioned into a first non-display area and a second non-display area formed at an external edge of a display area; a plurality of sensing patterns formed in a display area of the upper substrate that faces the lower substrate; sense lines formed in the first non-display area of the upper substrate and respectively connected with the sensing patterns; a sense pad formed in the second non-display area of the upper substrate and connected with the sense lines; resistance reducing lines formed in the first non-display area of the upper substrate and connected with at least a part of the sensing patterns; resistance reducing lines formed in the first non-display area of the upper substrate and connected with at least a part of the sensing patterns; a sealing member formed between the upper substrate and the non-display area of the lower substrate; metal patterns formed in the second non-display area of the lower substrate, overlapping with the sense pad and the sense resistance pad; and a conductive ball area provided between the sense pad, the resistance reducing pads, and the metal patterns of the lower substrate and including conductive balls.

The sense pad may include first connection patterns connected with the sense lines and second connection patterns electrically connected with the metal patterns in the lower substrate, and the resistance reducing pad may include third connection patterns connected with the resistance reducing lines and fourth connection patterns electrically connected with the metal patterns in the lower substrate.

The sense pad and the resistance reducing pad may be connected in parallel to one another.

The sense pad and the resistance reducing pad may be electrically connected with the metal patterns of the lower substrate through the conductive balls.

The conductive ball area may be filled with a paste, and the plurality of conductive balls may be randomly dispersed in the paste.

The plurality of conductive balls may include gold (Au).

The sealing member and the conductive ball area may be separated from each other.

The sensing patterns may include first sensing cells formed to be connected for each row line along a horizontal direction of the upper substrate, first connection lines connecting the first sensing cells, second sensing cells formed to be connected for each column line along a vertical direction of the upper substrate, and second connection lines connecting the second sensing cells.

The sense lines may include first sense lines connected with the first connection lines and second sense lines connected with the second connection lines, and including at least one of molybdenum (Mo), silver (Ag), titanium (Ti), copper (Cu), and aluminum (Al).

The first sense lines and the second sense lines may be provided at a distance from each other in the upper substrate.

The second sense line may be further layered in the first sense line, and the first sense line may be further layered in the second sense line.

The resistance reducing pad may be formed in at least one side of the upper substrate.

A flexible printed circuit board that is electrically connected with the metal patterns may be attached to an end of the second non-display area of the lower substrate.

The metal patterns may be connected with a driving IC mounted to the flexible printed circuit board.

A plurality of pixels may be formed in the display area of the lower substrate, and signal lines that electrically connect the plurality of pixels with the metal patterns formed in the second non-display area may be formed in the first non-display area of the lower substrate.

The signal lines may include scan lines and data lines.

A black matrix may be further formed in the first non-display area and the second non-display area of the upper substrate so as to be arranged at the edge of the display area.

According to another embodiment, a method of manufacturing a flat panel display comprises: forming an upper substrate and a lower substrate, each partitioned into a first non-display area and a second non-display area formed at an external edge of a display area; forming a plurality of sensing patterns in a display area of the upper substrate that faces the lower substrate; forming sense lines in the first non-display area of the upper substrate and respectively connected with the sensing patterns; forming a sense pad in the second non-display area of the upper substrate and connected with the sense lines; forming resistance reducing lines in the first non-display area of the upper substrate and connected with at least a part of the sensing patterns; forming a resistance reducing pad in the second non-display area of the upper substrate and including resistance reducing pads connected with the resistance reducing lines; forming a seal between the upper substrate and the non-display area of the lower substrate; forming metal patterns in the second non-display area of the lower substrate, overlapping with the sense pad and the sense resistance pad; and providing a conductive ball area between the sense pad, the resistance reducing pad, and the metal patterns of the lower substrate and including conductive balls.

As described, the touch screen panel is integrally formed in a lower portion of the upper substrate of the display panel so that the thickness of the flat panel display can be reduced and visibility of an image can be improved, and a resistance reducing pad is additionally formed in the touch sense pad so that resistance in wiring of the touch screen panel can be reduced.

### BRIEF DESCRIPTION OF THE DRAWINGS

FIG. 1 is a top plan view of an upper substrate of a flat panel display according to an embodiment.

FIG. 2 is a cross-sectional view of FIG. 1, taken along the line II-II.

FIG. 3 is an enlarged top plan view of a sense pad portion according to an embodiment.

FIG. 4 is an enlarged top plan view of a resistive sense pad portion according to an embodiment.

FIG. 5A and FIG. 5B are separate top plan views of the upper substrate and the lower substrate of the flat panel display according to an embodiment.

FIG. 6 is a cross-sectional view of a coupled state of FIG. 5A and FIG. 5B, taken along the lines VI-VI and VII-VII.

FIG. 7 is a cross-sectional view of the flat panel display in the coupled state of FIG. 5A and FIG. 5B along the Y-axis direction, including a pad unit.

FIG. 8 is a cross-sectional view of a flat panel display according to another embodiment.

### DETAILED DESCRIPTION OF CERTAIN INVENTIVE EMBODIMENTS

The present disclosure will be described more fully hereinafter with reference to the accompanying drawings, in which certain embodiments of the invention are shown. As those skilled in the art would realize, the described embodiments may be modified in various ways, without departing from the spirit or scope of the present invention.

In the drawings, the thickness of layers, films, panels, regions, etc., may be exaggerated for clarity. Like reference numerals generally designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are generally no intervening elements present.

Hereinafter, a flat panel display integrally provided with a touch screen panel according to an embodiment will be described with reference to the accompanying drawings.

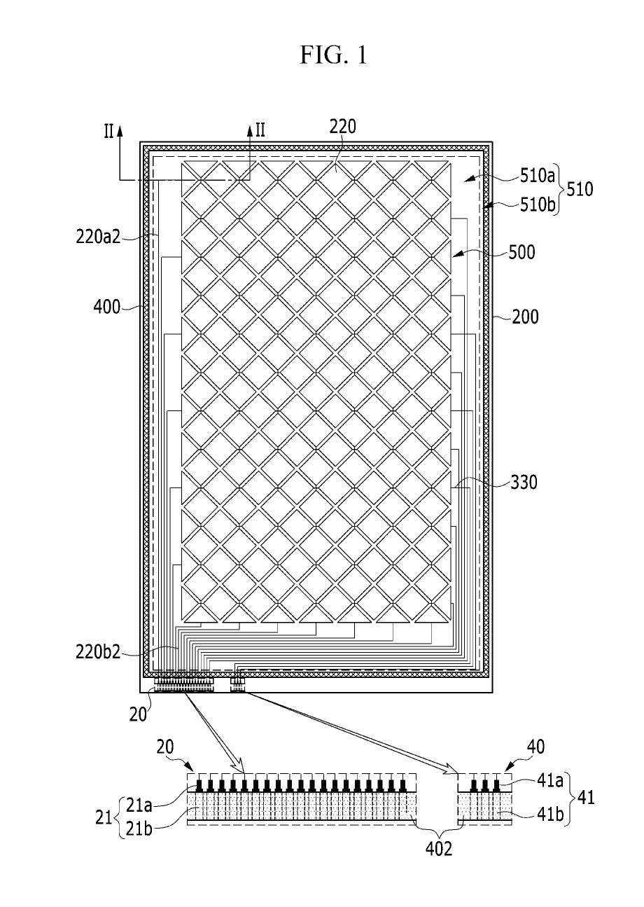

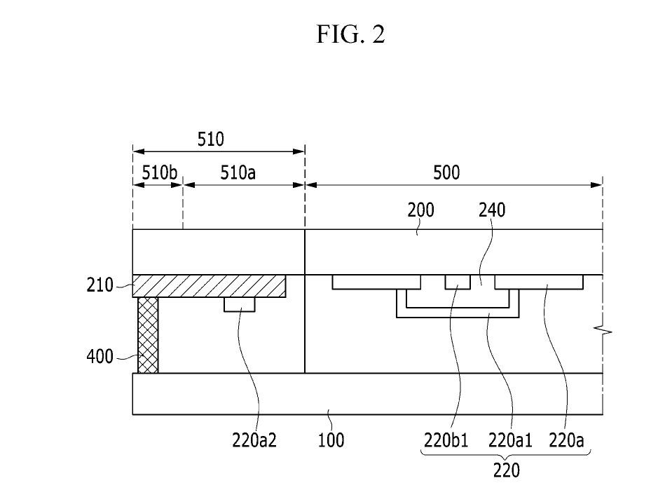

First, referring to FIG. 1 and FIG. 2, a flat panel display according to an embodiment will be described.

FIG. 1 is a top plan view of an upper substrate of the flat panel display according to an embodiment and FIG. 2 is a cross-sectional view of the flat panel display of FIG. 1, taken along the line II-II.

As shown in FIG. 1, a touch screen panel is directly formed in one surface of an upper substrate 200 in the flat panel display according to an embodiment. The surface of the upper substrate 200 where the touch screen panel is formed contacts a lower substrate that corresponds to the upper substrate, and corresponds to an inner surface of the upper substrate.

The flat panel display may be an organic light emitting device or a liquid crystal display, and in one embodiment, the flat panel display will be described as an organic light emitting device. Thus, the upper substrate 200 corresponds to an encapsulation substrate of the organic light emitting device and the upper substrate 200 can include a transparent material.

As shown in FIG. 1, the touch screen panel according to an embodiment includes sensing patterns 220 formed on the bottom surface of the upper substrate 200, sense lines 220a2 and 220b2 connecting the sensing patterns 220 with an external driving circuit (not shown) through a sense pad unit 20, and resistance reducing lines 330 reducing wiring resistance of the touch screen panel through a resistance reducing pad unit 40.

The sensing patterns 220 formed in the bottom surface of the upper substrate 200 of the flat panel display according to an embodiment may be formed in various shapes.

A region where the sensing patterns 220 are formed is a display area 500 where an image is displayed and a touch location is detected, and an area where the sense lines 220a2 and 220b2 electrically connected with the sensing patterns 220, the sense pad unit 20, the resistance reducing lines 330, and the resistance reducing pad unit 40 are formed is a non-display area 510 provided at an external edge of the display area 500.

The sense lines 220a2 and 220b2 include a first sense line 220a2 and a second sense line 220b2 that are formed separated from each other at different locations, respectively. As shown in FIG. 1, the first sense lines 220a2 may be formed in the left and right sides of the non-display area 510, and the second sense lines 220b2 may be formed below the non-display area 510.

In addition, the non-display area 510 is divided into a first non-display area 510a where the sense lines 220a2 and 220b2 are formed and a second non-display area 510b where the sense pad unit 20 formed of a plurality of sense pads 21 connected with the respective sense lines 220a2 and 220b2 and the resistance reducing pad unit 40 formed of a plurality of resistance reducing pads 41 respectively connected with the resistance reducing lines 330 are formed.

The second non-display area 510b is an area where a sealing member 400 provided between the upper substrate 200 and the lower substrate 100, to seal the upper substrate 200 and the lower substrate 100 together, is coated, and a laser beam is irradiated to the second non-display area 510a and the sealing member 400 is cured so that the upper substrate 200 and the lower substrate 100 are sealed to each other.

Each sense pad 21 is formed of a first connection pattern 21a connected with the sense lines 220a2 and 220b2 and a second connection pattern 21b electrically connected with a metal pattern (not shown) formed on the lower substrate 100 through a conductive ball area 402.

Each resistance reducing pad 41 is formed of a third connection pattern 41a connected with the resistance reducing line 330 and a fourth connection pattern 41b electrically connected with the metal pattern (not shown) formed on the lower substrate through the conductive ball area 402.

The conductive ball area 402 is an external side of a portion where the sealing member 400 is formed, and conductive balls (not shown) are randomly dispersed therein. The second connection pattern 21b and the fourth connection pattern 41b are provided on the conductive ball area 402.

The conductive ball area 402 is provided to electrically connect the sense pad unit 20 and the resistance reducing pad unit 40 formed in the upper substrate 200 with the metal pattern formed on the lower substrate 100, and may include conductive balls made of a conductive metallic material such as, for example, gold (Au), but this example is not restrictive.

The conductive ball has a size that corresponds to a gap between the upper substrate 200 and the lower substrate 100, but the size of the conductive ball may be smaller than or greater than the gap between the substrates 200 and 100.

The sense pad unit 20 is electrically connected with a flexible printed circuit board (FPCB) (not shown) attached to an end of the lower substrate 100, and the flexible printed circuit board may be electrically connected with a driving IC (not shown) that drives a plurality of pixels (not shown) provided in a pixel area of the lower substrate 100.

The resistance reducing pad unit 40 may also be connected with the flexible printed circuit board (FPCB) attached to the end of the lower substrate 100, and the flexible printed circuit board may be electrically connected with the driving IC or a power IC.

A touch panel driving circuit that drives the touch screen panel may be integrated with the driving IC, and although the driving IC is not illustrated, the driving IC may be directly mounted to the second non-display area or mounted to the flexible printed circuit board.

In the flat panel display according to an embodiment, the second connection patterns 21b of the sense pad 21 and the fourth connection patterns 41b of the resistance reducing pad 41 are electrically connected with the corresponding metal patterns (not shown) formed on the lower substrate 100 through the conductive ball area 402 for electrical connection between the sense pad 21 and the resistance reducing pad 41 formed on the upper substrate 200 and the flexible printed circuit board attached to the lower substrate 100.

Next, referring to FIG. 2, the sensing pattern 220 formed on the display area 500 of the upper substrate 200 includes a plurality of first sensing cells 220a formed to be connected to each other by each row line along a horizontal direction of the upper substrate 200, a plurality of first connection lines 220a1 connecting the first sensing cells 220a along the horizontal direction, a plurality of second sensing cells 220b formed to be connected to each other by each column line along a vertical direction, and a plurality of second connection lines 220b1 connecting the second sensing cells 220b along the vertical direction.

The sensing cells 220a and 220b may be formed in various shapes such as a diamond, a triangle, a circle, a quadrangle, and the like, and this list is not restrictive.

The sensing cells 220a and 220b may be arranged to not be overlapped with each other, the first connection lines 220a1 and the second connection lines 220b1 may cross each other, and an insulation layer 240 may be formed between the first connection lines 220a1 and the second connection lines 220b1.

Each of the sensing cells 220a and 220b may be integrally formed with each of the first connection lines 220a1 and each of the second connection lines 220b1 using a transparent electrode material such as, for example, indium tin oxide, or may be individually formed and then electrically connected with each other.

The first connection line 220a1 may directly contact the first sensing cell 220a and be electrically connected thereto at above or below the first sensing cell 220a, or may be electrically connected with the first sensing cell 220a through a contact hole.

Such a first connection line 220a1 may include a transparent electrode material such as, for example, ITO, or may include an opaque low-resistive material, and the width of the first connection line 220a1 may be controlled to prevent the patterns from being viewed.

The first connection line 220a1 and the second connection line 220b1 are respectively connected with a first sensing cell 220a of each row line unit and a second sensing cell 220b of each column line unit, and the first connection line 220a1 and the second connection line 220b1 are connected again with the first sense line 220a2 and the second sense line 220b2 at the edge of the sensing pattern 220 and then gathered to one end of the upper substrate 200, including an upper side of a lower side of the upper substrate 200, such that the first and second connection lines 220a1 and 220b1 are connected with an external driving circuit (not shown) such as a location detection circuit through the sense pad unit 20.

The sense lines 220a2 and 220b2 are arranged in the first non-display area 510a located at the external edge of the display area where the image is displayed, and may include various material including a transparent electrode material used for forming of the sensing pattern 220, and also a low resistive material such as, for example, molybdenum (Mo), silver (Ag), titanium (Ti), copper (Cu), aluminum (Al), molybdenum/aluminum/molybdenum (Mo/Al/Mo), and the like.

The resistance reducing line 330 may be electrically connected with the first sensing cell 220a of each row line unit and/or the second sensing cell 220b of the column line unit, may be connected to all the sensing cells 220a and 220b, or may be connected to a part of the first and second sensing cells 220a and 220b, and may connect the first and second sensing cells 220a and 220b to a circuit such as an external driving circuit (not shown) or a power circuit (not shown) through the resistance reducing pad unit 40.

Like the sense lines 220a2 and 220b2, the resistance reducing lines 330 are also arranged in the first non-display area 510a located at the external edge of the display area where the image is displayed, and may include various materials including a transparent electrode material used for forming of the sensing pattern 220, and also a low resistive material such as, for example, molybdenum (Mo), silver (Ag), titanium (Ti), copper (Cu), aluminum (Al), molybdenum/aluminum/molybdenum (Mo/Al/Mo), and the like.

A touch screen panel is a capacitive-type touch screen panel, and when a contact material such as a user's hand or a stylus pen contacts the touch screen panel, a capacitance variation according to a contact location is transmitted to the driving circuit from the sensing pattern 220 via the connection lines 220a1 and 220b1, the sense lines 220a2 and 220b2, and the sense pad unit 20, and the capacitance variation is converted to an electrical signal by an input processing circuit (not shown) and the line so that the contact location can be determined.

In addition, wiring resistance that may be generated in the sense lines 220a2 and 220b2 can be reduced through the resistance reducing line 330 and the resistance reducing pad unit 40.

In general, a metal wire is stacked to increase the thickness of the wiring to thereby reduce the resistance of the wiring, but in the touch screen panel according to an embodiment, the resistance reducing line 330 and the resistance reducing pad unit 40 are additionally connected in parallel with the sense pad unit 20 to reduce resistance.

As shown in FIG. 2, a black matrix 210 is formed in the non-display area 510 of the upper substrate 200 and is provided at the external edge of the display area 500, and the first sense lines 220a2 or the second sense lines 220b2 electrically connected with the sensing patterns 220 are respectively formed in the first non-display area 510a that overlaps the black matrix 210. In the second non-display area 510b, the sealing member 400 is formed for adhesion with the lower substrate 100.

The black matrix 210 formed in the non-display area 510 prevents patterns such as the sense lines 220a2 and 220b2 formed in the non-display area 510 from being viewed and at the same time forms an edge of the display area.

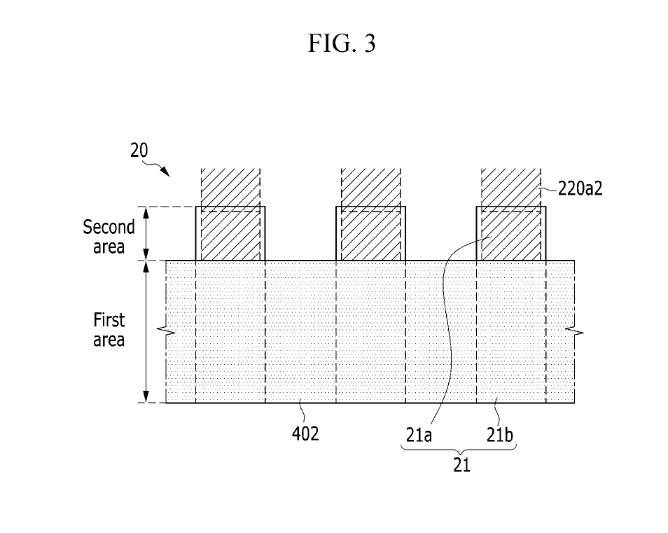

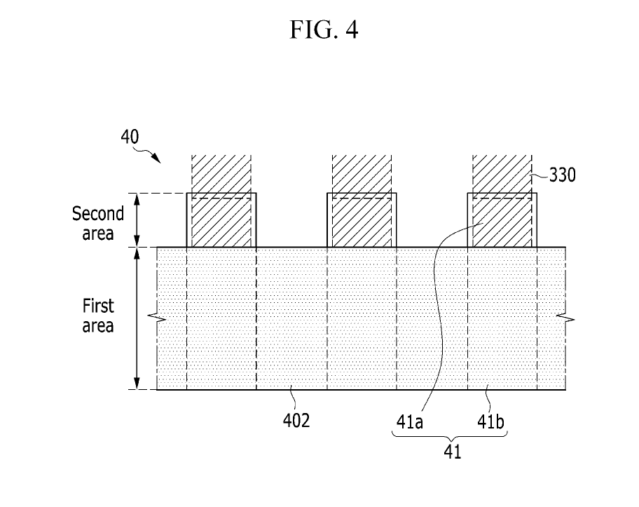

Hereinafter, the sense pad unit and the resistance reducing pad unit shown in FIG. 1 will be described in detail with reference to FIG. 3 and FIG. 4.

FIG. 3 is an enlarged top plan view of the sense pad unit according to an embodiment, and FIG. 4 is an enlarged top plan view of the resistance reducing pad unit according to an embodiment.

First, referring to FIG. 3, the sense pad unit 20 is formed of a plurality of sense pads 21, and the sense pads 21 are divided into a first area overlapping the conductive ball area 402 therebelow and a second area not overlapping the conductive ball area 402.

As shown in FIG. 1, the plurality of sense pads 21 are formed on the second non-display area 510b of the upper substrate 200, the sealing member 400 is formed in an inner side of the sense pad 21 as one area in a lower portion of the non-display area 510b, and the conductive ball area 402 is formed in an area overlapping the sense pad 21.

The plurality of sense pads 21 is formed of first connection patterns 21a respectively connected with the sense lines 220a2 and 220b2 and second connection patterns 21b electrically connected with metal patterns formed in the lower substrate 100, and the capacitance variation sensed from the sensing patterns 220 is transmitted to a driving circuit (not shown) mounted to the flexible printed circuit board (not shown) through the sense pads 21.

As an area overlapping the sense pad 21, the conductive ball area 402 where the conductive balls are randomly dispersed is formed in a lower portion of the area that overlaps the second connection patterns 21b for connection with the metal patterns formed in the lower substrate 100.

Referring to FIG. 4, the resistance reducing pad unit 40 is formed of the plurality of resistance reducing pads 41, and like the sense pads 21 of FIG. 3, the resistance reducing pads 41 are divided into a first area that overlaps the conductive ball area 402 therebelow and a second area that does not overlap the conductive ball area 402.

The plurality of resistance reducing pads 41 are provided on the second non-display area 510b of the upper substrate 200, the sealing member 400 is formed as one area in the lower portion of the second non-display area 510b in the inner side of the resistance reducing pad 41, and the conductive ball area 402 is formed in an area overlapping the resistance reducing pad 41.

The plurality of resistance reducing pads 41 are formed of third connection patterns 41a connected with the respective resistance reducing lines 330 and fourth connection patterns 41b electrically connected with the respective metal patterns (not shown) formed in the lower substrate 100, and wiring resistance generated from wires such as the sense lines 220a2 and 220b2 of the touch screen panel can be reduced through the plurality of resistance reducing pads 41.

As an area overlapping the resistance reducing pads 41, the conductive ball areas 402 where the conductive balls are randomly dispersed for electrical connection with the respective metal patterns formed in the lower substrate 100 is formed in a lower portion of the area that overlaps the fourth connection patterns 41b.

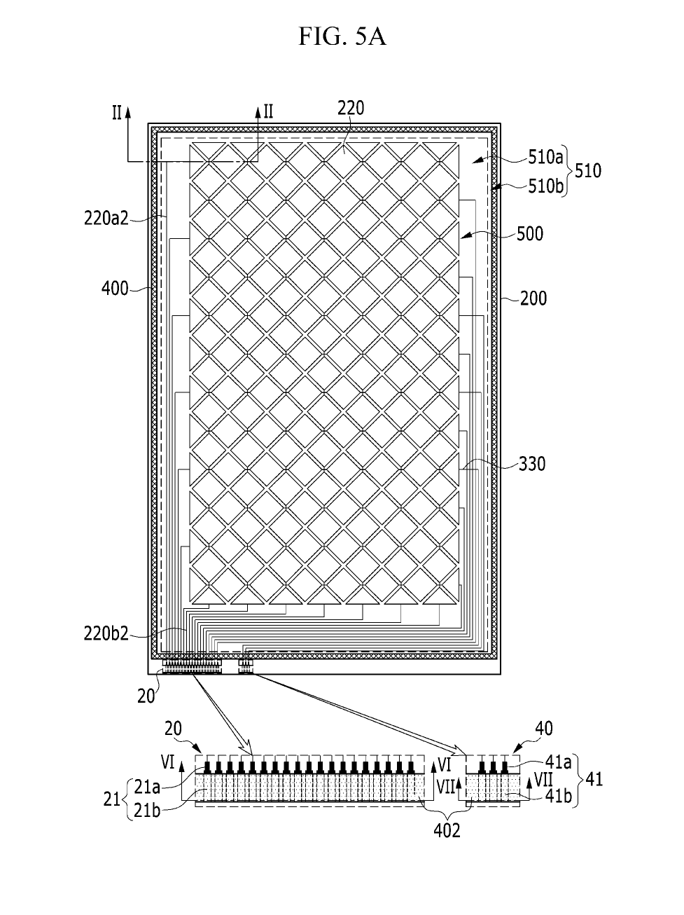

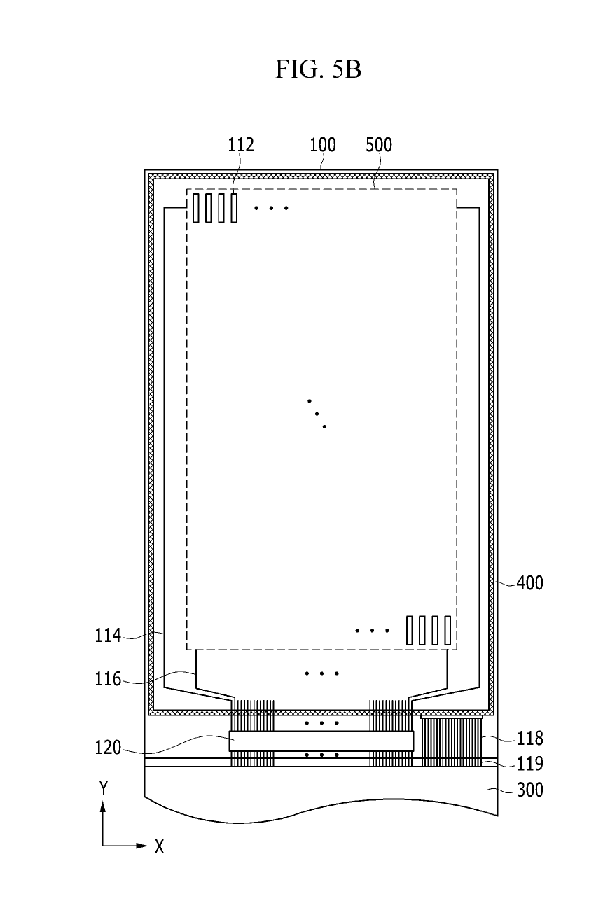

Now, referring to FIG. 5 to FIG. 7, a coupled state of an upper substrate and a lower substrate of a flat panel display where a touch screen panel is integrally formed will be described in detail.

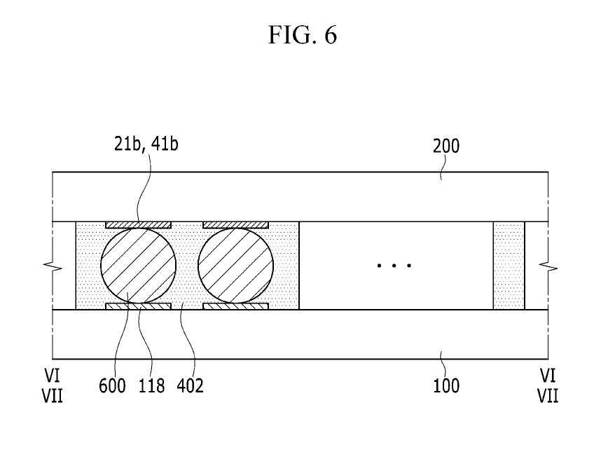

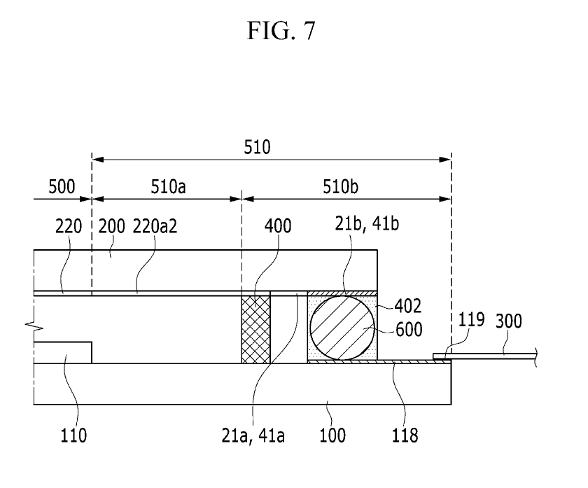

FIG. 5A and FIG. 5B are separated top plan views of the upper substrate and the lower substrate of the flat panel display according to an embodiment, FIG. 6 is a cross-sectional view of FIG. 5A and FIG. 5B along the lines VI-VI and VII-VII, and FIG. 7 is a cross-sectional view of FIG. 5A along the Y-axis direction, including a pad unit of FIG. 5A.

Referring to FIG. 5A and FIG. 5B, sensing patterns 220 and connection lines 220a1 and 220b1 that realize a touch screen panel may be formed at an inner side that seals pixels 112 with respect to a plurality of pixels 112 formed in a display area 500 of a lower substrate 100 in the flat panel display according to an embodiment.

The flat panel display may be exemplarily described as an organic light emitting device provided with an organic light emitting element, a thin film transistor, and a capacitor, but it is not limited thereto.

The connection lines 220a1 and 220b1 formed in the bottom surface of the upper substrate 200 are electrically connected with metal patterns 118 formed on the lower substrate 100 through sense pads 21 and then connected with a flexible printed circuit board 300 via the lower substrate 100.

The sense pad 21 may be connected with a driving IC 120 via the metal patterns 118 and the flexible printed circuit board PCB 300, and the driving IC 120 may include a control circuit for driving the display panel, a control circuit for driving the touch screen panel, or a location detection circuit.

Each sense pad 21 is formed of a first connection pattern 21a connected with the sense lines 220a2 and 220b2 and a second connection pattern 21b electrically connected with the metal patterns 118 formed on the lower substrate 100 through a conductive ball area 402, and as shown in FIG. 6 and FIG. 7, the second connection patterns 21b of the sense pads 21 are electrically connected with the lower substrate 100 through the metal patterns 118 formed in the upper surface of the lower substrate 100 through conductive balls 600 that are randomly dispersed in the conductive ball area 402.

The conductive balls 600 may include a plurality of metallic conductive balls having conductivity, and made include, for example, gold (Au) but this is not restrictive.

The conductive ball area 402 may be formed by filling conductive balls 600 therein in a paste form.

Each of the conductive balls may have a size that corresponds to a gap between the upper substrate 200 and the lower substrate 100, but the size of each conductive ball 600 may be smaller or greater than the gap between the substrates 200 and 100.

Thus, the touch screen panel and the display panel are connected to the flexible printed circuit board 300 and then shared.

In addition, each resistance sense pad 41 is formed of third connection patterns 41a connected with resistance reducing lines 330 and fourth connection patterns 41b connected with the metal patterns (not shown) formed on the lower substrate 100 through the conductive ball area 402, and as shown in FIG. 6 and FIG. 7, the fourth connection patterns 41b of the resistance reducing pads 41 are electrically connected with the lower substrate 100 by the metal patterns 118 formed on the upper surface of the lower substrate 100 through the conductive balls 600 that are randomly dispersed in the conductive ball area 402.

The conductive balls 600 may include metallic conductive balls having conductivity, and may include, for example, gold (Au) but this is not restrictive.

Each of the conductive balls may have a size that corresponds to a gap between the upper substrate 200 and the lower substrate 100, but the size of each conductive ball 600 may be smaller or greater than the gap between the substrates 200 and 100.

The conductive ball area 402 may be formed by filling conductive balls 600 in a paste.

Thus, the resistance reducing pads 41 and the display panel of the touch screen panel are connected to the flexible printed circuit board 300 and thus resistance in wiring can be reduced.

The flexible printed circuit board 300 is connected to one end of the lower substrate 100 so as to be electrically connected with signals lines of the display panel, such as scan lines 114 and data lines 116 and provide a control signal for controlling the display panel, and is also connected with the sense pads 21 through a metal pad 119 and the metal patterns 118 connected with the metal pad 119 so as to supply a control signal for controlling the touch screen panel. In addition, the flexible printed circuit board 300 may be connected with the resistance reducing pads 41 to reduce resistance in wiring.

The flexible printed circuit board 300 is realized by integrating a flexible printed circuit board for driving the display panel and a flexible printed circuit board for driving the touch screen panel.

A display area 500 where a plurality of pixels, each including a pixel electrode of, for example, a liquid crystal display, or an organic light emitting element of an organic light emitting device, and a thin film transistor that drives the pixel electrode or the organic light emitting element are formed in the lower substrate 100 of the display panel, and the driving IC 120 may be mounted to one side of the lower substrate 100 for controlling an image displayed in the display area 500, as necessary.

As described, the resistance reducing pad unit 40 of the flat panel display is located beside the sense pad unit 20, but the resistance reducing pad unit 40 may be provided at any location, such as another side of the flat panel display or an upper side or a bottom side of the flat panel display.

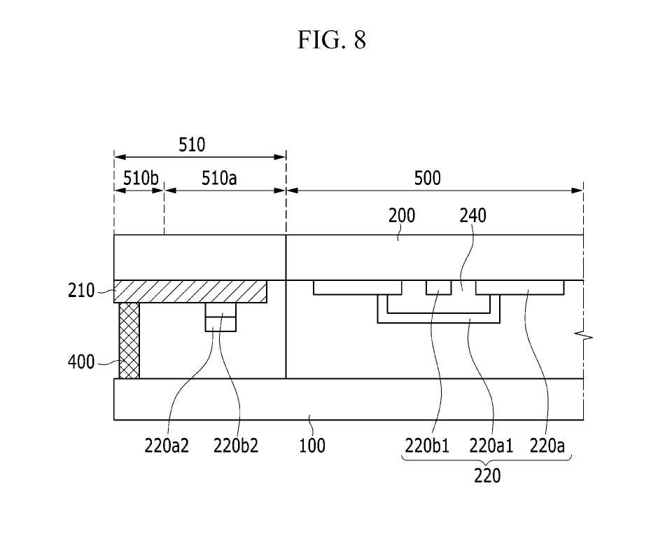

Referring to FIG. 8, a touch screen panel of a flat panel display according to another embodiment will be described.

FIG. 8 is a cross-sectional view of a flat panel display according to another embodiment.

The embodiment of FIG. 8 is the same as the embodiments of FIG. 1 to FIG. 7, except for a first sense line 220a2 and a second sense line 220b2 formed in sense lines 220a2 and 220ba, and therefore repeated descriptions will be omitted.

As shown in FIG. 8, the first sense line 220a2 is additionally layered with the sense line 220b2 of the touch screen panel, compared to embodiments in which the first sense line 220a2 and the second sense lines 220b2 are respectively provided in different locations.

In addition, although it is not illustrated, the first sense line 220a2 may be additionally layered in the second sense line 220b2.

In general, a metal wire is layered to reduce resistance in wiring, but in one embodiment, the first sense lines 220a2 and the second sense lines 220b2 are further formed and layered respectively in the sense lines 220a2 and 220b2 when manufacturing the first sense lines 220a2 and the second sense lines 220b2 so that resistance in wiring of the touch screen panel can be reduced.

As described, in the flat panel display, the touch screen panel is integrally formed in a lower portion of the upper substrate of the display panel so that the thickness of the flat panel display can be reduced and visibility of an image can be improved, and a resistance reducing pad is additionally formed in the touch sense pad so that resistance in wiring of the touch screen panel can be reduced.

While this invention has been described in connection with certain embodiments, it is to be understood that the invention is not limited to the disclosed embodiments, but, on the contrary, is intended to cover various modifications and equivalent arrangements included within the spirit and scope of the appended claims.

<Description of Symbols>

| | |
|---|---|
| 100: lower substrate | 200: upper substrate |
| 220: sensing pattern | 220a1, 220b1: connection line |
| 220a2, 220b2: sense line | 120: driving IC |
| 300: flexible printed circuit board | 400: sealing member |
| (PCB) | |
| 402: conductive ball area | 500: display area |
| 510: non-display area | 600: conductive ball |
| 330: resistance reducing line | 40: resistance reducing pad unit |
| 41: resistance reducing pad | 20: sense pad unit |
| 21: sense pad | 240: insulating layer |
| 210: black matrix | 112: pixel |
| 114: scanning line | 116: data line |
| 118: metal pattern | 119: metal pad |

What is claimed is:

1. A flat panel display comprising:
an upper substrate and a lower substrate, each partitioned into a first non-display area and a second non-display area formed at an external edge of a display area;
a plurality of sensing patterns formed in a display area of the upper substrate that faces the lower substrate;
sense lines formed in the first non-display area of the upper substrate and respectively connected with the sensing patterns;
a sense pad formed in the second non-display area of the upper substrate and connected with the sense lines;
resistance reducing lines formed in the first non-display area of the upper substrate and connected with at least a part of the sensing patterns;
a resistance reducing pad formed in the second non-display area of the upper substrate and including resistance reducing pads connected with the resistance reducing lines;
a sealing member formed between the upper substrate and the non-display area of the lower substrate;
metal patterns formed in the second non-display area of the lower substrate, overlapping with the sense pad and the sense resistance pad; and
a conductive ball area provided between the sense pad, the resistance reducing pads, and the metal patterns of the lower substrate and including conductive balls.

2. The flat panel display of claim 1, wherein
the sense pad comprises first connection patterns connected with the sense lines and second connection patterns electrically connected with the metal patterns in the lower substrate, and
the resistance reducing pad comprises third connection patterns connected with the resistance reducing lines and fourth connection patterns electrically connected with the metal patterns in the lower substrate.

3. The flat panel display of claim 2, wherein the sense pad and the resistance reducing pad are connected in parallel to one another.

4. The flat panel display of claim 2, wherein the sense pad and the resistance reducing pad are electrically connected with the metal patterns of the lower substrate through the conductive balls.

5. The flat panel display of claim 4, wherein the conductive ball area is filled with a paste, and the plurality of conductive balls are randomly dispersed in the paste.

6. The flat panel display of claim 5, wherein the plurality of conductive balls include gold (Au).

7. The flat panel display of claim 4, wherein the sealing member and the conductive ball area are separated from each other.

8. The flat panel display of claim 1, wherein the sensing patterns comprise
first sensing cells formed to be connected for each row line along a horizontal direction of the upper substrate and first connection lines connecting the first sensing cells, and
second sensing cells formed to be connected for each column line along a vertical direction of the upper substrate and second connection lines connecting the second sensing cells.

9. The flat panel display of claim 8, wherein sense lines comprise first sense lines connected with the first connection lines and second sense lines connected with the second connection lines, and including at least one of molybdenum (Mo), silver (Ag), titanium (Ti), copper (Cu), or aluminum (Al).

10. The flat panel display of claim 8, wherein the first sense lines and the second sense lines are provided at a distance from each other in the upper substrate.

11. The flat panel display of claim 8, wherein the second sense line is further layered in the first sense line, and the first sense line is further layered in the second sense line.

12. The flat panel display of claim 1, wherein the resistance reducing pad is formed in at least one side of the upper substrate.

13. The flat panel display of claim 1, wherein a flexible printed circuit board that is electrically connected with the metal patterns is attached to an end of the second non-display area of the lower substrate.

14. The flat panel display of claim 13, wherein the metal patterns are connected with a driving IC mounted to the flexible printed circuit board.

15. The flat panel display of claim 13, wherein a plurality of pixels are formed in the display area of the lower substrate, and signal lines that electrically connect the plurality of pixels with the metal patterns formed in the second non-display area are formed in the first non-display area of the lower substrate.

16. The flat panel display of claim 15, wherein the signal lines comprise scan lines and data lines.

17. The flat panel display of claim 8, wherein a black matrix is further formed in the first non-display area and the second non-display area of the upper substrate so as to be arranged in the edge of the display area.

18. The flat panel display of claim 1, wherein the metal patterns are formed at external edges of the sealing member.

19. A method of manufacturing a flat panel display, the method comprising:
forming an upper substrate and a lower substrate, each partitioned into a first non-display area and a second non-display area formed at an external edge of a display area;
forming a plurality of sensing patterns in a display area of the upper substrate that faces the lower substrate;
forming sense lines in the first non-display area of the upper substrate and respectively connected with the sensing patterns;
forming a sense pad in the second non-display area of the upper substrate and connected with the sense lines;
forming resistance reducing lines in the first non-display area of the upper substrate and connected with at least a part of the sensing patterns;
forming a resistance reducing pad in the second non-display area of the upper substrate and including resistance reducing pads connected with the resistance reducing lines;
forming a seal between the upper substrate and the non-display area of the lower substrate;
forming metal patterns in the second non-display area of the lower substrate, overlapping with the sense pad and the sense resistance pad; and
providing a conductive ball area between the sense pad, the resistance reducing pad, and the metal patterns of the lower substrate and including conductive balls.

20. The method of manufacturing a flat panel display of claim 19, wherein
connection patterns are connected with the sense lines and with second connection patterns electrically connected with the metal patterns in the lower substrate, and
third connection patterns are connected with the resistance reducing lines and fourth connection patterns are electrically connected with the metal patterns in the lower substrate.
